(19) United States
(12) Patent Application Publication
(10) Pub. No.: US 2010/0254140 A1
(43) Pub. Date: Oct. 7, 2010

(54) LAMP HOLDER OF LED STREETLAMP WITH HEAT-CONDUCTING AND HEAT-DISSIPATING CAPABILITY

(76) Inventors: Fong-Yuan WEN, Taoyuan City (TW); Hung-Tsung HSU, Taoyuan City (TW)

Correspondence Address: HDLS Patent & Trademark Services, P.O. BOX 220746, CHANTILLY, VA, 20153-0746, US

(21) Appl. No.: 12/419,396

(22) Filed: Apr. 7, 2009

(51) Int. Cl. F21V 21/00; F21V 29/02

(52) U.S. Cl. 362/249.02; 362/373

(57) ABSTRACT

A lamp holder of a LED streetlamp includes a lamp cover, a LED unit and a plurality of heat-conducting posts. The LED unit is provided below the lamp cover. A transparent lamp cover covers outside the LED unit. Further, the heat-conducting posts are arranged upright in the lamp cover and separated from each other by a distance. Each of the heat-conducting posts is connected to the inner edge surface of the lamp cover opposite to the LED unit and extends toward the top edge of the lamp cover to be located between the top and bottom of the lamp cover. On both sides of the lamp cover laterally facing the heat-conducting posts, venting holes are provided to form an open structure, thereby allowing outside air to enter the lamp cover and flow among the heat-conducting posts.

### BACKGROUND OF THE INVENTION

1. Field of the Invention

The present invention relates to a LED streetlamp, and in particular to a lamp holder of a LED streetlamp with heat-conducting and heat-dissipating capability.

2. Description of Prior Art

Since light-emitting diodes (LED) have many advantages such as high brightness, low power consumption and long lifetime, they are widely used to the lighting for electronic devices or lamps. In order to increase the illuminating range and brightness, a plurality of LED is assembled together to form a LED lamp, which can be mounted in a lamp holder of a streetlamp to replace the traditional bulb.

When using LED as a light source of a streetlamp, it is an important issue to dissipate the heat generated by the high power of LED. In the conventional heat-dissipating structure of a LED streetlamp, the heat-conducting structure is embedded in the lamp holder of the streetlamp. The only heat-dissipating mechanism is to utilize heat-dissipating fins protruding from the top surface of the lamp holder so as to contact the outside air. However, such a structure makes the heat generated by the LED to be accumulated in the lamp holder easily, which may affect the heat-dissipating effect negatively. Especially, since the casing of the lamp holder is not sealed completely, dust may be accumulated on the surface of the internal heat-dissipating structure after a long period of time. As a result, the dust may block the contact with outside air and thus reduce the heat-dissipating capacity.

Therefore, in order to overcome the above problems, the present Inventor proposes a reasonable and novel structure based on his delicate researches and expert experiments.

### SUMMARY OF THE INVENTION

The present invention is to provide a lamp holder of a LED streetlamp with heat-conducting and heat-dissipating capability. An open lamp cover is provided to allow outside air to enter therein. A plurality of strip-like heat-conducting posts is provided to conduct the heat, thereby dissipating the heat generated by the LED from the bottom of the lamp cover to its top. On the other hand, by means of the pitch between the respective heat-conducting posts as well as the contact with outside air, a better heat-dissipating effect can be achieved. Since each of the heat-conducting posts is arranged upright and detachably, dust may not be accumulated on the peripheral surfaces of the heat-conducting posts easily. The number of the heat-conducting posts can be adjusted according to the desired heat-conducting efficiency. The open lamp cover can completely utilize the air convection in all directions, thereby reducing the accumulation of dust and providing a better heat-dissipating effect.

The present invention is to provide a lamp holder of a LED streetlamp with heat-conducting and heat-dissipating capability, which includes a lamp cover, a LED unit and a plurality of heat-conducting posts. The LED unit is provided below the lamp cover. A transparent lamp cover covers outside the LED unit. Heat-conducting posts are arranged upright in the lamp cover and separated from each other by a distance. Each of the heat-conducting posts is connected to the inner edge surface of the lamp cover opposite to the LED unit and extends toward the top edge of the lamp cover so as to be located between the top and bottom of the lamp cover. On both sides of the lamp cover laterally facing the heat-conducting posts, venting holes are provided to form an open structure. Via this arrangement, the outside air can enter the lamp cover to flow freely among the respective heat-conducting posts.

### BRIEF DESCRIPTION OF THE DRAWINGS

FIG. 1 is an exploded perspective view of the present invention;

FIG. 2 is an assembled perspective view of the present invention along another viewing angle;

FIG. 3 is an exploded view showing the heat-conducting posts and the base of the present invention; and

FIG. 4 is an assembled cross-sectional view of the present invention.

### DETAILED DESCRIPTION OF THE INVENTION

In order to make the Examiner to better understand the characteristics and technical contents of the present invention, a detailed description relating thereto will be explained with reference to the accompanying drawings. However, the drawings are illustrative only but not used to limit the present invention.

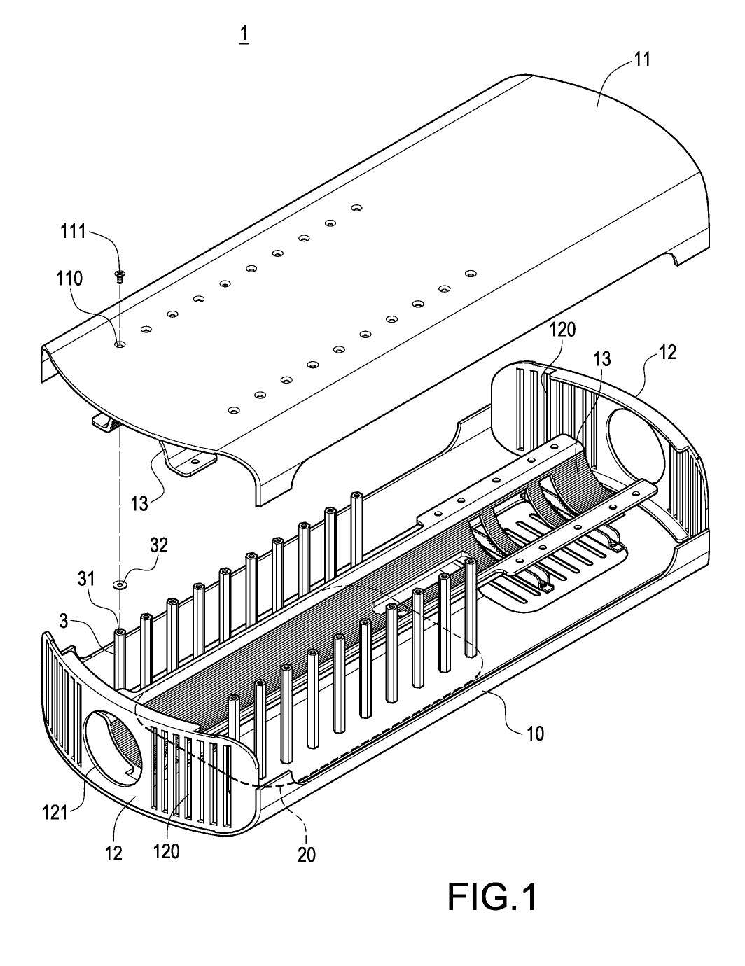

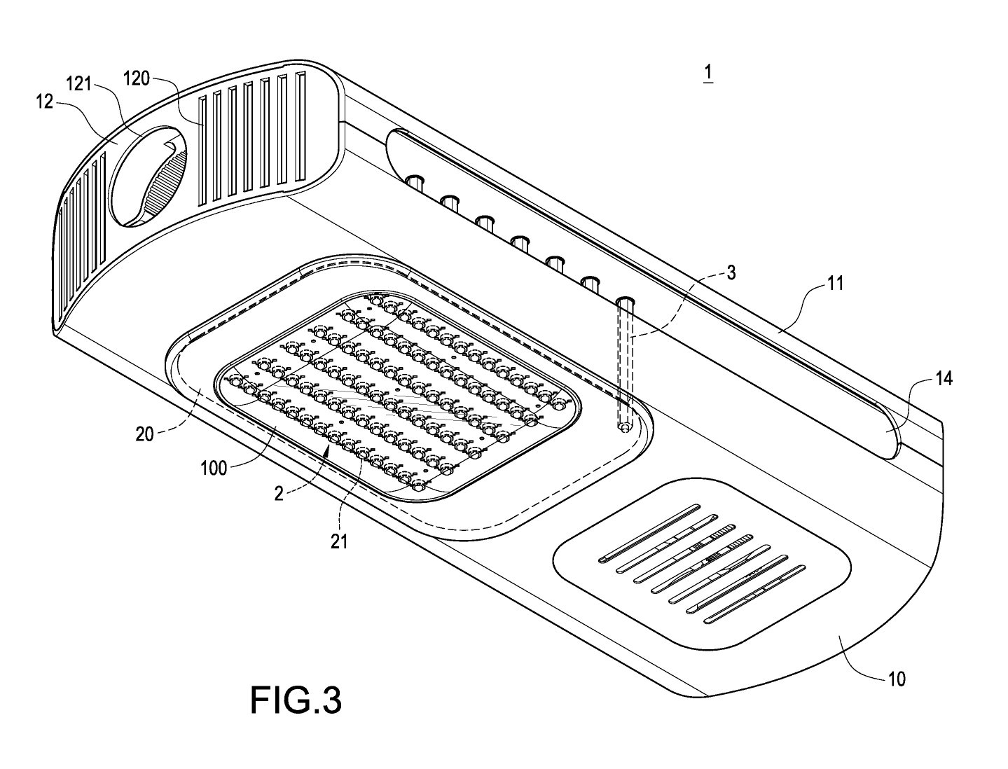

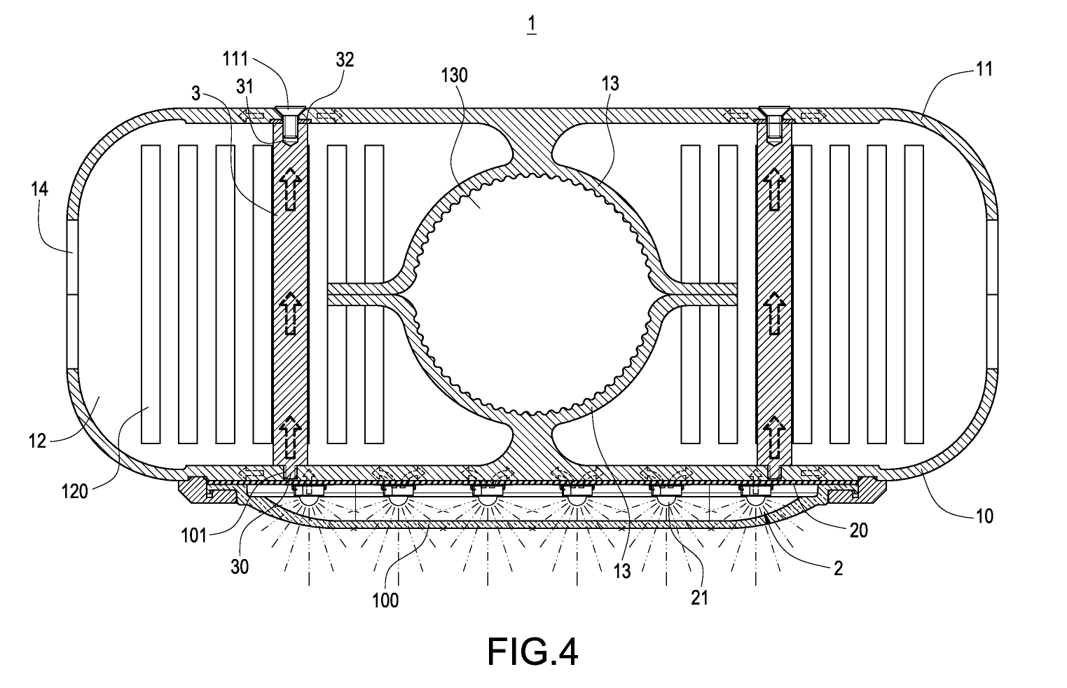

Please refer to FIG. 1, which is an exploded perspective view of the present invention. The present invention provides a lamp holder of a LED streetlamp with heat-conducting and heat-dissipating capability, which includes a lamp cover 1, a LED unit 2 and a plurality of heat-conducting posts 3. The LED unit 2 is assembled below the lamp cover 1 (FIG. 3) for illumination. The heat-conducting posts 3 are upright provided in the lamp cover 1 to contact the inner edge surface of the lamp cover 1 facing the LED unit 2, thereby extending toward the top of the lamp cover 1 to conduct the heat (FIG. 4).

The lamp cover 1 is constituted of a base 10 and an upper cover 11. The upper cover is made of a heat-conducting material. The LED unit 2 is accommodated below the base 10. The front and rear sides of the base 10 are provided with an upright shielding plate 12 respectively for allowing the upper cover 11 to straddle between the two shielding plates 12. The two shielding plates 12 are provided with a plurality of stripe-like air holes 120. Inside the lamp cover 1, a semi-arc locking piece 13 is provided on the corresponding inner edge surfaces of the base 10 and the upper cover 11 respectively. After the base 10 is assembled with the upper cover 11, the respective locking pieces 13 can be combined with each other, thereby forming a locking hole 130 for allowing a lamp post (not shown) of a streetlamp to pass through (FIG. 4). At the same time, the middle portion of the shielding plate 12 is provided with a corresponding through-hole 121 for allowing the lamp post of the streetlamp to pass through.

The LED unit 2 comprises a circuit board 20 and a plurality of light-emitting diodes 21 provided on the circuit board 20. According to the above, the LED unit 2 is provided below the lamp cover 1 (i.e. outside the bottom surface of the base 10), so that the light provided by the respective LED 21 of the LED unit 2 can project toward the underside of the lamp cover 1 (FIG. 4). A transparent lamp cover 100 covers outside the LED unit 2. The transparent lamp cover 100 is also provided below the lamp cover 1.

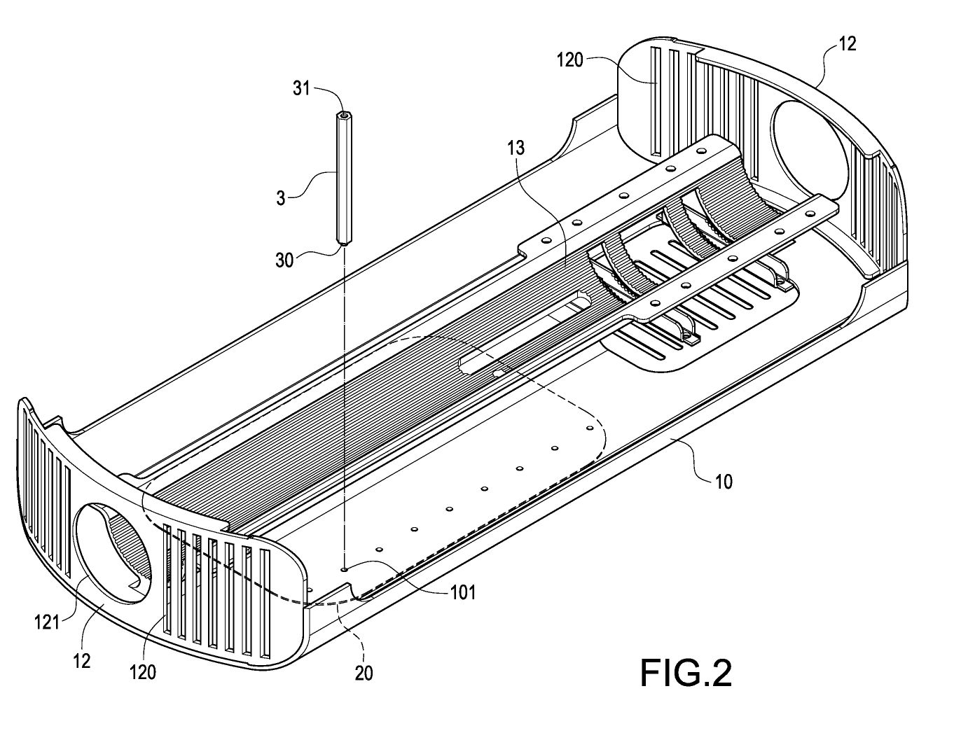

The heat-conducting posts 3 are formed into strips and arranged upright in the lamp cover 1 between the base 10 and the upper cover 11. The pitch between the heat-conducting posts 3 allows the air to flow freely in all directions. The cross-sectional area of each heat-conducting post 3 through which the heat can be conducted to the upper cover 11 and the area of the peripheral surface of the heat-conducting post are together utilized to provide the maximum heat-dissipating effect. Please also refer to FIG. 2, in the present embodiment, the distal end of each heat-conducting piece 3 is provided with an outer screw rod 30. The outer screw rod 30 is screwed into a screw hole 101 provided on the base 10, so that the distal end of the heat-conducting post 3 is brought into contact and connection with the base 10. Each of the screw holes 101 is provided on the inner edge surface of the lamp cover 1 opposite to the LED unit 2. The top end of the each heat-conducting post 3 is provided axially and inwardly with an inner screw hole 31 to correspond to the through-hole 110 of the upper cover 11. Each of the through-holes 110 is provided on the top surface of the upper cover 11. With fastening elements 111 (such as screws) penetrating into the through-hole 110 to be fastened into the inner screw hole 31, the top end of the heat-conducting post 3 is brought into contact and connection with the upper cover 11. A gasket 32 made of heat-conducting material is additionally provided between the top end of each heat-conducting post 3 and the upper cover 11. Alternatively, heat-conducting medium (not shown) such as heat-conducting paste or glue can be applied between the heat-conducting post 2 and the base 10 or between the heat-conducting post 2 and the upper cover 11.

In addition, on both sides of the lamp cover 1 laterally facing the heat-conducting posts 3, venting holes 14 are provided to form an open structure. Via this arrangement, outside air can flow into the lamp cover 1 freely, thereby generating a good convection among the respective heat-conducting posts 3.

Therefore, via the above-mentioned structure, the lamp holder of a LED streetlamp with heat-conducting and heat-dissipating capability according to the present invention can be obtained.

According to the above, as shown in FIG. 4, since the lamp cover 1 is a casing of an open structure, it allows outside air to enter therein. At the same time, each of the heat-conducting posts 3 is located between the top and bottom surfaces of the lamp cover 1, so that the heat generated by the LED unit 2 below the lamp cover 1 can be conducted from the bottom of the lamp cover 1 to its top, thereby facilitating the heat dissipation of the LED unit 2. Further, via the pitch between the respective heat-conducting posts 3, the outside air can flow into the lamp cover 1 freely. The peripheral surfaces of the respective heat-conducting posts 3 are used as an area for heat dissipation. When the air flows among the respective heat-conducting posts 3, the air can be brought into contact with the peripheral surfaces of the heat-conducting posts 3 to carry a portion of heat away. Further, the number of the heat-conducting posts 3 can be increased or reduced to achieve the maximum heat-dissipating effect according to the practical heat-conducting efficiency.

Thus, according to the lamp holder of a LED streetlamp with heat-conducting and heat-dissipating capability, since the peripheral surfaces of respective heat-conducting posts 3 are arranged upright, dust may not be accumulated on the peripheral surfaces easily. The open lamp cover 1 allows the air to flow therein freely in all directions. No only the accumulation of dust can be reduced, but also the respective heat-conducting posts 3 can be brought into contact with the outside air. Thus, the air can flow much better and more efficiently, thereby utilizing the natural convection completely to achieve a better heat dissipation.

According to the above, the present invention really achieves the desired objects and solves the problems of prior art. Furthermore, the present invention demonstrates novelty and inventive steps and thus conforms to the requirements for a utility model patent.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A lamp holder of a LED streetlamp with heat-conducting and heat-dissipating capability, comprising:
a lamp cover;
a LED unit provided below the lamp cover, a transparent lamp cover covering outside the LED unit; and
a plurality of heat-conducting posts arranged upright in the lamp cover and separated from each other by a distance, each of the heat-conducting posts being connected to the inner edge surface of the lamp cover opposite to the LED unit and extending toward the top edge of the lamp cover so as to be located between the top and bottom of the lamp cover;
wherein on both sides of the lamp cover laterally facing the heat-conducting posts, venting holes are provided to form an open structure, whereby outside air can enter the lamp cover to flow among the heat-conducting posts.

2. The lamp holder of a LED streetlamp with heat-conducting and heat-dissipating capability according to claim 1, wherein the inner edge surfaces of the top and bottom of the lamp cover are provided with a semi-arc locking piece respectively, thereby forming a locking hole for allowing a lamp post of a streetlamp to pass through and locked therein.

3. The lamp holder of a LED streetlamp with heat-conducting and heat-dissipating capability according to claim 1, wherein the lamp cover is constituted of a base and an upper cover, the upper cover is made of a heat-conducting material, the LED unit is provided below the base, the heat-conducting posts are located between the base and the upper cover.

4. The lamp holder of a LED streetlamp with heat-conducting and heat-dissipating capability according to claim 3, wherein the front and rear sides of the base are provided with an upright shielding plate respectively, the upper cover straddles between the two shielding plates.

5. The lamp holder of a LED streetlamp with heat-conducting and heat-dissipating capability according to claim 4, wherein the two shielding plates are provided with a plurality of strip-like air holes.

6. The lamp holder of a LED streetlamp with heat-conducting and heat-dissipating capability according to claim 1, wherein the LED unit comprises a circuit board and a plurality of light-emitting diodes provided on the circuit board.

7. The lamp holder of a LED streetlamp with heat-conducting and heat-dissipating capability according to claim 1, wherein the distal end of each heat-conducting post is provided with an outer screw rod, a corresponding screw hole is provided in the bottom of the lamp cover, the outer screw of each heat-conducting post is screwed into the screw hole.

8. The lamp holder of a LED streetlamp with heat-conducting and heat-dissipating capability according to claim 7, wherein heat-conducting medium is applied between each heat-conducting post and the bottom of the lamp cover.

9. The lamp holder of a LED streetlamp with heat-conducting and heat-dissipating capability according to claim 1, wherein the top of each heat-conducting post is provided axially and inwardly with an inner screw hole, the top of the lamp cover is provided with a corresponding through-hole, a fastening element passes through the through-hole and is fastened into the inner screw hole of each heat-conducting post.

10. The lamp holder of a LED streetlamp with heat-conducting and heat-dissipating capability according to claim 9, wherein heat-conducting medium is applied between each heat-conducting post and the top of the lamp cover.

11. The lamp holder of a LED streetlamp with heat-conducting and heat-dissipating capability according to claim 9, wherein a gasket made of heat-conducting materials is provided between each heat-conducting post and the top of the lamp cover.

12. The lamp holder of a LED streetlamp with heat-conducting and heat-dissipating capability according to claim 9, wherein the fastening element is a screw.
